(19) United States
(12) Patent Application Publication
(10) Pub. No.: US 2015/0026081 A1
(43) Pub. Date: Jan. 22, 2015

(54) METHOD AND SYSTEM FOR MANAGING STANDARDS

(71) Applicant: APOLLO GROUP, INC., Phoenix, AZ (US)

(72) Inventors: CORA COLEBANK, Phoenix, AZ (US); LARRY MOLMUD, Monterey, CA (US)

(21) Appl. No.: 13/944,032

(22) Filed: Jul. 17, 2013

(51) Int. Cl. G06Q 30/00

(52) U.S. Cl. CPC G06Q 30/018
USPC 705/317

(57) ABSTRACT

A method and system are disclosed for automatically managing standards. In one implementation, information pertaining to a particular project is obtained, which includes a set of standards selection parameters. A repository is also accessed. This repository includes metadata for a plurality of standards, wherein the metadata for a standard includes a description and one or more applicability parameters. Based upon the standards selection parameters and the metadata, a set of standards that apply to the particular project is determined. For each standard in the set of standards, a description is extracted from the repository. Using the extracted descriptions, a project description for the particular project is generated that includes the extracted descriptions. By doing this, the method and system relieve a project builder of the burden of having to manually incorporate standard description information into a project description. This in turn helps to reduce the potential for error.

### FIELD OF THE INVENTION

The present invention relates generally to computer systems and more particularly to a method and system for managing standards.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In building a project, there are often many standards that need to be met. For example, in the academic realm, when a faculty member builds a course, there are many standards that need to be met in order for that course to satisfy national, state, organizational, accreditation, and other requirements. If the course does not satisfy these standards, adverse consequences may result, such as non-accreditation, legal liability, etc. Often, the standards that apply to a project need to be included in a description of the project. For example, in the academic realm, a course syllabus needs to include information describing the various standards that apply to that course. Thus, in building a project, a project builder often needs to know all of the standards that apply to that project, and often needs to include, in a description of the project, information describing the various standards that apply to the project.

Typically, a project builder has to create a project description manually. This usually entails the project builder performing research to determine which standards apply to the project, and then manually incorporating into the project description information that describes the applicable standards. For example, in the academic realm, a creator of a course usually performs research to determine all of the standards that apply to that course, and then inserts, into a syllabus, description information that describes each of the applicable standards. This can be a tedious and laborious task, especially given that there are often many standards that may potentially apply, that each state or organization may have different standards, that certain standards may only apply under certain conditions (e.g. certain standards may apply only to courses that are available on certain dates), etc. Overall, the manual process is fraught with potential for error, such as including descriptions for standards that do not apply, or worse yet, not including descriptions for standards that do apply. Such errors may lead to grave consequences. For example, in the academic realm, if a course syllabus does not include information describing all of the standards that apply to that course, the course may not qualify for accreditation. Given the shortcomings of the current manual methodology, an improved methodology is needed for managing standards.

### BRIEF DESCRIPTION OF THE DRAWINGS

FIG. 1 is a functional block diagram of a sample system in which one embodiment of the present invention may be implemented.

FIG. 2 shows a flow diagram illustrating how a project description may be automatically generated for a particular project, in accordance with one embodiment of the present invention.

FIG. 3 shows a sample metadata schema for an educational standard, in accordance with one embodiment of the present invention.

FIG. 4 is a block diagram of a sample computer system that may be used to implement at least a portion of the present invention.

### DETAILED DESCRIPTION OF EMBODIMENT(S)

### Overview

In accordance with one embodiment of the present invention, a method and system are provided for automatically managing standards. As used herein, the term standard refers broadly to any standard, requirement, restriction, condition, specification, code, rule, law, etc., that needs to be satisfied or met. With this method and system, the standards that are applicable to a particular project are automatically determined, and a project description, which includes descriptions of the applicable standards, is automatically generated. With this method and system, a project builder is relieved of the burden of having to manually incorporate standard description information into a project description. By relieving the project builder of this burden, the method and system are not only easing the workload of the project builder but are also significantly reducing the potential for error. Thus, this embodiment of the present invention provides a significantly improved mechanism for managing standards and for automatically generating a project description for a project.

In one embodiment, a project description for a particular project (for purposes of the present invention, the particular project may be any type of project, including but certainly not limited to an educational course, a construction project, a product design, a product build, a software product design, etc.) may be automatically generated as follows. Initially, information pertaining to the particular project is obtained. This information may include a set of one or more standards selection parameters that can be used to determine which one or more standards are applicable to the particular project. A repository is also accessed. This repository includes metadata for a plurality of standards that may apply to various projects. In one embodiment, the metadata for each standard includes a description associated with that standard and one or more applicability parameters that can be used to determine whether that standard applies to one or more projects. Based at least in part upon the one or more standards selection parameters of the particular project and the metadata in the repository, a determination is made as to which standard or standards apply to the particular project. The result of this determination is a set of one or more standards that are applicable to the particular project. For each standard in this set of standards, a description associated with the standard is extracted from the repository. Using the extracted descriptions, a project description for the particular project is generated, which includes the descriptions associated with each of the standards in the set of standards. In this manner, a project description for the particular project may be automatically generated. By doing so, the project builder is relieved of the burden of having to manually incorporate standard description information into a project description. This in turn helps to reduce the potential for error.

### Sample System

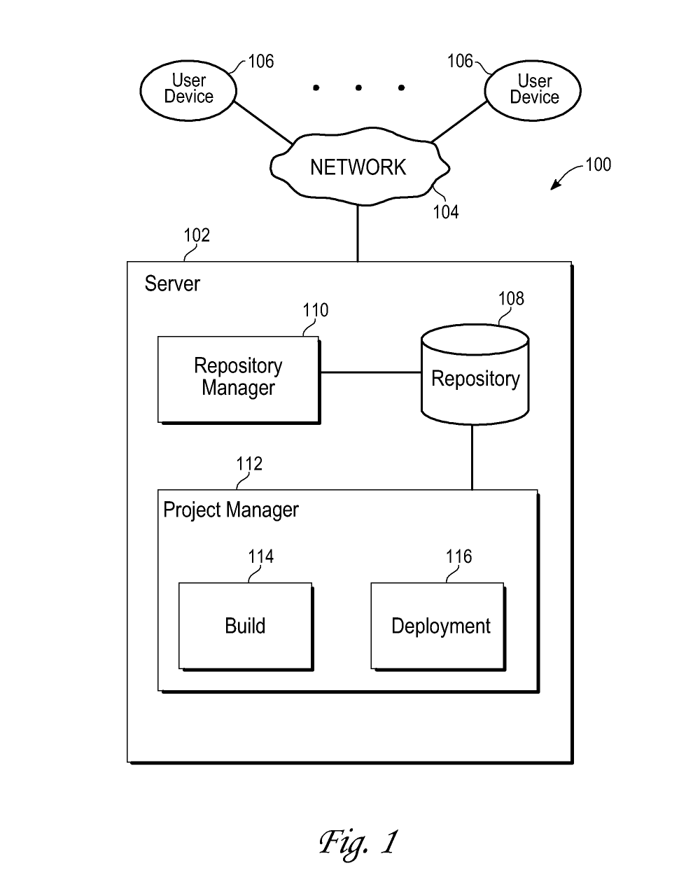

With reference to FIG. 1, there is shown a functional block diagram of a sample system 100 in which one embodiment of the present invention may be implemented. As shown, system 100 comprises a server 102 coupled to a network 104, which in turn is coupled to one or more user devices 106. For purposes of the present invention, the network 104 may be any type of network, such as a local area network (LAN), a wide area network (WAN) (e.g. the Internet), or any other type of network that enables communication to be effected between the one or more user devices 106 and the server 102. For purposes of the present invention, the user devices 106 may take on any of various forms, including but not limited to desktop computers, laptop computers, tablet computers, smartphones, mobile devices, etc. The user devices 106 may execute a web browser or one or more other applications to interact with the server 102. The web browser or other application may implement a user interface and/or an application programming interface (API) to enable a user to use a user device 106 to interact with the server 102. Various users may use a user device 106 to interact with the server 102 for various purposes. For example, an end user may use a user device 106 to access one or more services provided by the server 102. A project builder may use a user device 106 to interact with the server 102 to build a project. An administrator may use a user device 106 to interact with the server 102 to deploy a project, to automatically generate a project description for a project, or to update information in a repository. These and other users may use the user devices 106 to interact with the server 102 for these and other purposes. All such interactions are within the scope of the present invention.

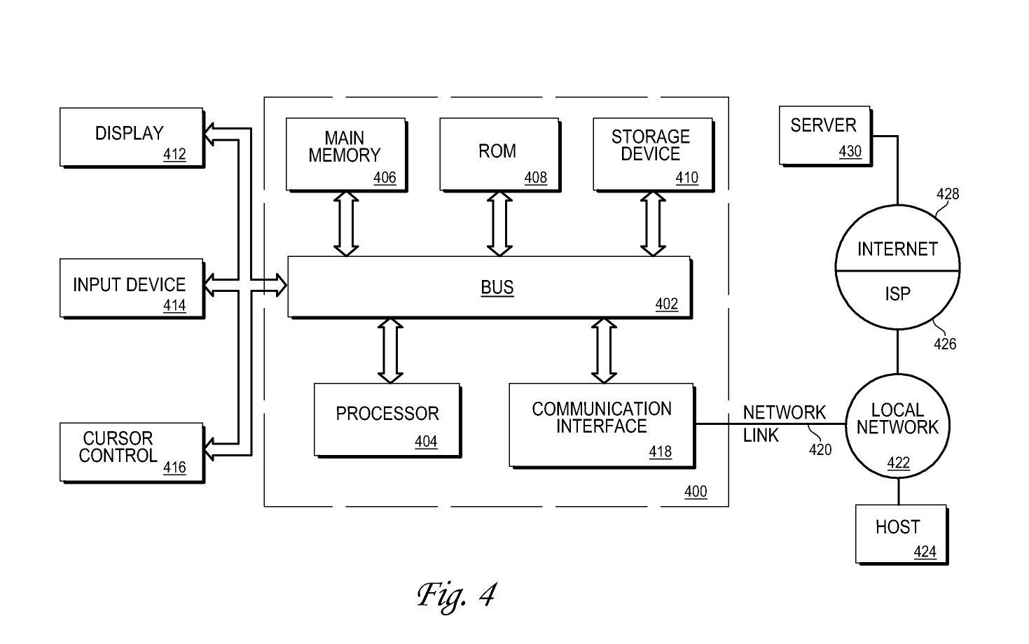

As shown in FIG. 1, the server 102, in one embodiment, may comprise a repository 108, a repository manager 110, and a project manager 112. It should be noted that these are just some of the components that may be implemented on the server 102. Other components, not shown, may be implemented as well if so desired. In one embodiment, the server 102 may be implemented as one or more computer systems, such as the sample computer system shown in FIG. 4, which will be described in a later section. If the server 102 is implemented as a single computer system, then all of the components 108, 110, 112 may be implemented on that computer system. If the server 102 is implemented as multiple computer systems, then the various components 108, 110, 112 may be implemented on various computer systems in various combinations. For example, each of the components 108, 110, 112 may be implemented on a separate computer system, or components 108 and 110 may be implemented on one computer system while component 112 is implemented on another, or components 108 and 112 may be implemented on one computer system while component 110 is implemented on another, or some other combination may be used. For purposes of the present invention, the server 102 may be implemented using any number of computer systems, and the components 108, 110, 112 of the server 102 may be implemented on any of the computer systems in any desired combination.

In one embodiment, the repository 108 stores metadata pertaining to a plurality of standards. The plurality of standards may be a comprehensive set of all of the standards that may potentially apply to any project. In one embodiment, the repository 108 contains a set of metadata for each of the standards. The metadata for a standard may include identifying data for the standard (e.g. a unique identifier, a name, etc.). The metadata may also include a description associated with the standard. In one embodiment, it is this description that is extracted and inserted into a project description that is automatically generated for a project, as will be elaborated upon in a later section. The description for a standard may take the form of plain text, rich text, markup language (e.g. html, xml, etc.), or some other form. An advantage of rich text or markup language is that it enables formatting information to be included with the description. With this formatting information, the description may be rendered in a project description with specific formatting (e.g. paragraph separations, line spacing, bolding, underlining, indentations, etc.), which may be desired or required in some implementations. In addition to or in lieu of text, a description may include a reference (e.g. a link) to an object, which may, for example, be an image, a bitmap file, a pdf file, etc. When the description is included in a project description, the referenced object may be accessed and inserted into the project description. These and other types of information may be included in the description for a standard. The metadata for a standard may further include one or more applicability parameters. In one embodiment, it is these applicability parameters that are used to determine whether a standard is applicable to a project. Examples of applicability parameters will be provided in a later section. In addition to the above information, the metadata for a standard may further include other types of information. For purposes of the present invention, any desired information may be included in the metadata for a standard.

In addition to storing metadata for the various standards, repository 108 may also store other information, such as information pertaining to one or more projects. These and other types of information may be stored in the repository 108.

For purposes of the present invention, the information in the repository 108 may be stored in any form using any type of data structure. For example, the information may be stored in one or more files, in one or more tables, as comma separated values, as linked lists, in a flat database, in a hierarchical database, in a relational database, or in any other type of format or data structure. If the information is stored in a database, such as a relational database, the repository 108 may include a database manager (not shown) that receives and processes queries to find, update, and extract information from the repository 108. All such embodiments of the repository 108 are within the scope of the present invention.

Information in the repository 108 (e.g. the metadata for the standards) may be maintained via the repository manager 110. In one embodiment, the repository manager 110 may be invoked by a user via one of the user devices 106 to add information, delete information, or update information in the repository 108. For example, the repository manager 110 may be invoked by a user to provide metadata for a new standard, to delete metadata for an existing standard, to update metadata for an existing standard, etc. In the case where the repository 108 is a database that includes a database manager, the repository manager 110 may interact with the repository 108 by submitting one or more queries to the database manager. In the case where the repository manager 110 can access the repository 108 directly, the repository manager 110 may manipulate the information in the repository 108 directly. In one embodiment, since information in the repository 108 may be sensitive, only certain users, such as certain administrators with sufficient privileges, may invoke the repository manager 110.

The server 102 further comprises a project manager 112. In one embodiment, it is the project manager 112 that enables a user, using a user device 106, to build and deploy a project. Using the build component 114 of the project manager 112, a user may start a new project or update an existing project. As part of working with a project, the user may add or remove items from the project. The user may also specify one or more standards selection parameters for the project. These parameters are some of the parameters that may be used to determine which standard or standards apply to the project. As an example, suppose a user (e.g. a faculty member) invokes the build component 114 of the project manager 112 to build an educational course. As part of the build process, the user may add one or more content objects (e.g. books, papers, audio recordings, videos, etc.) and assessment objects (e.g. test questions, quizzes, exams, etc.) to the course, or may remove previously included content objects and assessment objects from the course. The user may also specify one or more standards selection parameters for the course. For example, the user may specify whether national standards should apply to the project, whether state standards should apply, whether organization standards should apply, etc. The user may also specify a course code or course type for the course. These standards selection parameters may be used to determine which standard or standards are applicable to the course. Information pertaining to a project, including the standards selection parameters and other information, may be stored in the repository 108 (or some other repository) by the build component 114 for later use.

After a project is created, it may at some point be deployed. Before a project is deployed, it may be thought of as a template for the project. Once a project is deployed, the deployed project may be thought of as an actual instance of the project. In one embodiment, to deploy a project, the deployment component 116 of the project manager 112 is invoked. The deployment component 116 may be invoked by a user (e.g. an administrator), via a user device 106, or it may be invoked automatically by some other component (not shown), such as an application. When the deployment component 116 is invoked, the invoking entity (user or component) may provide one or more additional standards selection parameters that may be used to determine which standard or standards are applicable to the project. For example, using the educational course example started above, the invoking entity may specify a date on which the course is to be deployed (e.g. made available to students) and a location (e.g. a state) at which the course will be available. These additional standards selection parameters may be used in conjunction with the standards selection parameters provided during the build process to determine which standard or standards are applicable to the project. In one embodiment, as part of deploying a project, the deployment component 116 automatically determines which standards are applicable to the project, and automatically generates a project description for the project that includes descriptions for all of the standards that apply to the project. The deployment component 116 may perform other deployment tasks as well (e.g. instantiating objects in the project, making the project accessible to users, etc.).

### Operational Overview

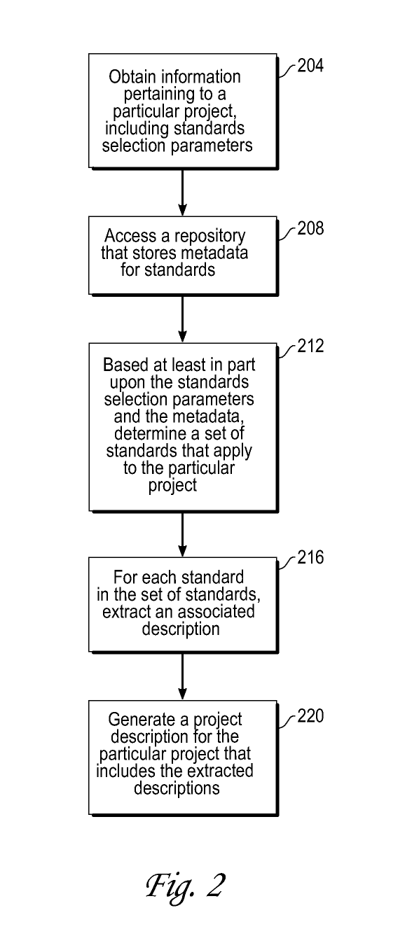

To describe how a project description may be automatically generated for a particular project in accordance with one embodiment of the present invention, reference will be made to the flow diagram of FIG. 2. As shown in FIG. 2, the process begins with obtaining (block 204) information pertaining to the particular project that is being deployed. In one embodiment, the deployment component 116 may perform this operation by accessing (from repository 108 or another repository) the build information for the particular project. Among other things, this build information includes the standards selection parameters (if any) that were specified for the particular project during build time. Also, when the deployment component 116 is invoked to deploy the particular project, the invoking entity may provide one or more additional standards selection parameters for the particular project. These additional standards selection parameters may be combined with the standards selection parameters provided during build time to form an overall set of standards selection parameters for the particular project.

The repository 108 is then accessed (block 208). As described previously, the repository 108 stores metadata for the standards that may apply to projects. The metadata for each standard includes at least a description associated with the standard and one or more applicability parameters that can be used to determine whether the standard applies to a project. Based at least in part upon the standards selection parameters for the particular project, and the metadata in the repository 108, a determination is made (block 212) as to which one or more standards apply to the particular project. This determination may be made, for example, by determining which standard or standards have applicability parameters that satisfy the standards selection parameters of the particular project. In one embodiment, the standards selection parameters of the particular project may be separated into subsets, and the subsets may be applied separately to the applicability parameters of the standards. Hence, a standard may be determined to apply to the particular project even if its applicability parameters satisfy only a subset of the standards selection parameters of the particular project. In one embodiment, the deployment component 116 determines how the standards selection parameters of the particular project are applied to the applicability parameters of the standards based upon a set of rules. These rules may be hardcoded into the deployment component 116 or they may be specified in a set of configuration information that is processed by the deployment component 116. As a result of this determination operation, a set of one or more standards that apply to the particular project is derived. For each standard in this set of standards, a description associated with the standard is extracted (block 216) from the metadata in the repository 108. As a result of this operation, the deployment component 116 has the descriptions associated with the standards that apply to the particular project.

With regard to operations 208, 212, and 216, which component performs these operations depends upon how the metadata in the repository 108 is stored and managed. If the metadata in the repository 108 can be accessed and manipulated directly by the deployment component 116, then operations 208, 212, and 216 may be performed by the deployment component 116 directly. However, if the metadata in the repository 108 is stored in a database, such as a relational database, that is managed by a database manager, then the operations 208, 212, 216 may be performed by the database manager in response to one or more queries from the deployment component 116. In either case, it is the deployment component 116 that controls and drives the process.

Once the deployment component 116 has one or more of the descriptions associated with the standards that apply to the particular project, the deployment component 116 may proceed to generate (block 220) the project description for the particular project. In generating the project description, the deployment component 116 may insert each of the descriptions associated with the standards into the project description. If a description associated with a standard is in plain text, the deployment component 116 inserts the text of the description into the project description. If the description associated with a standard is in a form (e.g. rich text, html, etc.) that includes formatting information, then the deployment component 116 may render the description in accordance with the formatting information, and insert the formatted version of the description into the project description. If the description associated with a standard includes a reference to another object (e.g. an image, a file, etc.), the deployment component 116 may access the referenced object and insert it into the project description, or may simply insert the reference to the object into the project. In one embodiment, the deployment component 116 performs the above for each of the descriptions associated with the standards that apply to the particular project. Hence, when fully generated, the project description will include all of the descriptions for all of the standards that apply to the particular project.

In the manner described, the standards that are applicable to a particular project may be automatically determined, and a project description, which includes descriptions of the applicable standards, may be automatically generated, in accordance with one embodiment of the present invention.

### Specific Use Case

The above discussion describes the process of automatically generating a project description for a particular project at a relatively general level. To provide additional context to facilitate a complete understanding of the present invention, a specific use case will now be described. In the following use case, it will be assumed that the project being built and deployed is an educational course, and that the project description being generated is a syllabus for the course. It should be noted that this use case is provided for illustrative purposes only. The invention is not so limited. Rather, many other use cases are possible, and all such use cases are within the scope of the present invention.

### Metadata Schema for an Educational Standard

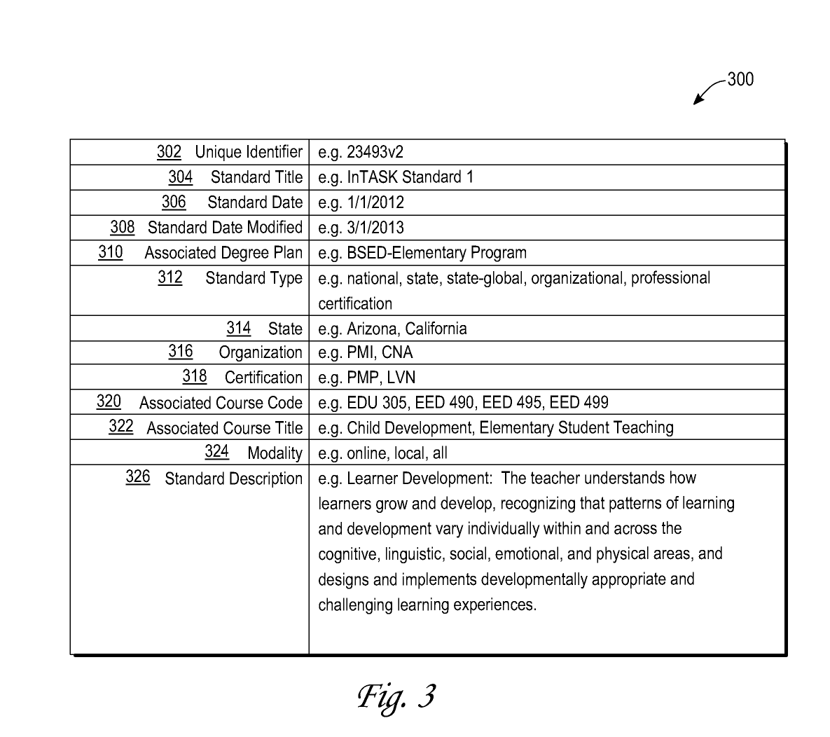

As noted previously, repository 108 stores metadata for the standards that may be applicable to one or more projects. In the current use case in which the project is an educational course, the standards that may apply are educational standards. For an educational standard, certain sets of information (i.e. metadata) are pertinent. In FIG. 3, there is shown a sample metadata schema 300 that may be used for an educational standard. This schema 300 represents the metadata that may be stored and maintained for each of the educational standards. It should be noted that schema 300 is shown for illustrative purposes only. Other schemas with additional or different sets of metadata may be used, if so desired.

As shown, the schema 300 includes a unique identifier field 302. This field contains a system wide unique identifier for an educational standard. This unique identifier may be system-assigned at the time a new or modified educational standard is added to the repository 108. In one embodiment, the unique identifier may include a version indicator (in the example shown, the version indicator “v2” indicates a second version of the standard). When a standard is modified, a new set of metadata (having the same schema but different metadata values) is created for the modified standard. The modified standard is assigned the same identifier as the current standard except that the version indicator is updated to the next version. Managing the identifiers in this manner enables the standards to be easily identified as being modified versions of each other while at the same time allowing each version to have its own unique identifier and its own set of metadata values. The schema 300 also includes a standard title field 304. This field contains a title or a name for the standard.

The schema 300 also includes a standard date field 306. In one embodiment, this field stores the date on which a set of metadata for a standard was created and stored in the repository 108. The schema 300 also includes a standard date modified field 308. This field stores a date (if any) on which the set of metadata for the standard was modified. When the metadata for a standard is modified, the metadata for the current version of the standard will have its standard date modified field 308 updated to reflect the date on which the modification took place, and the metadata for the modified version of the standard will have its standard date field 306 updated to reflect the date on which the modification place. For example, the metadata shown in FIG. 3 shows the metadata for a standard having identifier 23493v2 that was created on Jan. 1, 2012 and modified on Feb. 1, 2013. When the standard was modified on Mar. 1, 2013, a new set of metadata would have been created and stored for the modified version of the standard. The modified standard would have an identifier 23493v3 stored in the unique identifier field 302. It would also have the date 3/1/2013 stored in the standard date field 306 (this was the date on which the metadata for the modified standard was created), and no date or “null” stored in the standard date modified field 308 (since the modified standard has itself not been modified). These sets of metadata enable the progression of a standard to be tracked.

The schema 300 also includes an associated degree plan field 310. The information in this field specifies the one or more degree plans with which the standard is associated.

The schema 300 further includes a standard type field 312. The information in this field indicates a type for the educational standard. In the current use case, an educational standard may be one of five types: national, state, state-global, organizational, and professional certification. If an educational standard is of type “national”, then it means that the standard applies in all states. Note though that the standard does not necessarily apply to all courses in all states. Rather, for this type of standard, one or more course codes would be specified in the associated course code field 320. Together, these two sets of information indicate that the standard applies to all states for the course or courses specified in field 320. If an educational standard is of type “state”, then it means that the standard applies in one or more specific states. The state or states in which the standard applies is specified in the state field 314. Also, for this type of standard, one or more codes would be specified in the associated course code field 320. Together, these sets of information indicate that the standard applies to the state or states specified in field 314 for the course or courses specified in field 320. If an educational standard is of type “state-global”, then it means that the standard applies to all courses in one or more specific states. The state or states in which the standard applies is specified in the state field 314. For this type of educational standard, no courses need to be specified in the associated course code field 320 since the standard applies to all courses in the specified state or states. If an educational standard is of type “organizational”, then it means that the standard applies to certain organizations. The organization or organizations to which the standard applies is specified in the organization field 316. Also, for this type of educational standard, one or more codes would be specified in the associated course code field 320. Together, these sets of information indicate that the standard applies to the organization or organizations specified in field 316 for the course or courses specified in field 320. Finally, if an educational standard is of type “professional certification”, then it means that the standard applies to one or more certification types. The certification type or types to which it applies is specified in the certification field 318. Also, for this type of educational standard, one or more codes would be specified in the associated course code field 320. Together, these sets of information indicate that the standard applies to the certification type or types specified in field 318 for the course or courses specified in field 320.

The schema 300 further includes an associated course title field 322. This field may contain one or more course titles associated with the one or more course codes specified in field 320.

The schema 300 further includes a modality field 324. The information in this field indicates the types of courses to which the standard applies. For example, the standard may apply to courses that are available online, to courses that are available locally (at a particular location), to all courses regardless of whether they are accessible online or locally, etc.

Finally, the schema 300 includes a standard description field 326. This field contains the description associated with the standard. It is the information in this field that is extracted and included in a syllabus for a course if the standard is determined to be applicable to the course. The information in this field may be in plain text, or in some other form (e.g. rich text, html, etc.) that includes formatting information. Further, the information in this field may include one or more references (e.g. links) to one or more objects.

In the schema 300 shown in FIG. 3, certain territorial assumptions are made (for example, a single country is assumed, and states within the country are assumed). For implementations that span across multiple countries, a country field may be added to specify the country or countries to which a standard applies. Also, to remove the assumption of a country with states, the state field 314 may be generalized to a “location” field, where the location may have any desired granularity (e.g. city, county, zip code, postal code, etc.). These and other modifications may be made to the schema 300.

In schema 300, any one of the data fields may be used as an applicability parameter to determine whether an educational standard applies to a course. However, in the current use case, the main applicability parameters are stored in fields 306, 308, 312, 314, 316, 318, 320, and 324.

### Course Building

A user (e.g. a faculty member), via one of the user devices 106, may invoke the build component 114 of the project manager 112 to build an educational course. As part of the build process, the user may add one or more content objects (e.g. books, papers, audio recordings, videos, etc.) and assessment objects (e.g. test questions, quizzes, exams, etc.) to the course, or may remove previously included content objects and assessment objects from the course.

The user may also specify one or more standards selection parameters for the course. In the current use case, the user may specify which type or types of standard the user would like to have applied to the course. For example, the user may specify whether national standards, state standards, state-global standards, organizational standards, and/or professional certification standards (see field 312 of schema 300) should apply to the course. The user may also specify a course code (see field 320 of schema 300) for the course. This course code indicates the type of course (e.g. a basic economics course, an intermediate child development course, etc.) that the user is building. These and potentially other standards selection parameters may be specified by the user at build time. These parameters will be used to determine which standard or standards are applicable to the course during deployment time.

The information pertaining to the course, including the standards selection parameters and other information (e.g. content and assessment objects, or just references or links thereto) may be stored in the repository 108 (or some other repository) by the build component 114 for later use.

### Course Deployment and Automatic Syllabus Generation

Once built, a course may be deployed by invoking the deployment component 116 of the project manager 112. The deployment component 116 may be invoked by a user (e.g. an administrator), via a user device 106, or it may be invoked automatically by some other component (not shown), such as an application. For the sake of illustration, it will be assumed in the current use case that the deployment component 116 is invoked by a user via a user device 106. Upon invoking the deployment component 116, the user may provide one or more additional standards selection parameters for the course. In the current use case, the user may specify the state or states (see field 314 of schema 300) in which the course will be offered, the date on which the course will be made available, and whether the course is available online, locally, or both (see field 324 of schema 300). These and other standards selection parameters may be specified by the user at deployment time. These parameters may be used in conjunction with the standards selection parameters provided during build time to determine which standard or standards are applicable to the course, as will be described below.

As part of deploying the course, the deployment component 116 automatically generates a syllabus for the course. To do so, the deployment component 116 initially accesses the build information for the course. This build information may be accessed from repository 108 or from some other repository. From this build information, the deployment component 116 obtains the standards selection parameters that were specified by the course builder during build time, which in the current use case includes a course code and one or more indications of which types of standards are to be applied to the course. For the sake of example, it will be assumed that the course code for the course is EDU 305, and that the course builder specified that national, state, and state-global standards are to be applied to the course. It will also be assumed that the user invoking the deployment component 116 indicated that the course will be offered in the state of Arizona, that the course will be made available starting Aug. 1, 2013, and that the course will be available online. Together, these parameters form the complete set of standards selection parameters for the course for the current example.

Based on these standards selection parameters and the metadata stored in repository 108, all of the standards that apply to the course can be determined. To do so, the following standards are identified:

(1) standards where “national” is in the standard type field 312, “EDU 305” is included in the associated course code field 320, “online” or “all” is in the modality field 324, a date less than or equal to Aug. 1, 2013, is in the standard date field 308, and a null or a date greater than Aug. 1, 2013, is in the standard date modified field;

(2) standards where “state” is in the standard type field 312, “Arizona” is included in the state field 314, “EDU305” is included in the associated course code field 320, “online” or “all” is in the modality field 324, a date less than or equal to Aug. 1, 2013, is in the standard date field 308, and a null or a date greater than Aug. 1, 2013, is in the standard date modified field; and

(3) standards where “state-global” is in the standard type field 312, “Arizona” is included in the state field 314, “online” or “all” is in the modality field 324, a date less than or equal to Aug. 1, 2013, is in the standard date field 308, and a null or a date greater than Aug. 1, 2013, is in the standard date modified field.

In the current use case, a standard is applicable to the course if its metadata satisfies any one of the sets of conditions set forth above in (1), (2), and (3). Once identified, these standards represent the set of standards that apply to the course. For each of these applicable standards, the associated standard description found in field 326 is extracted.

If the deployment component 116 can access and manipulate the metadata in repository 108 directly, then the deployment component 116 can perform the processing necessary to identify the applicable standards and to extract the associated descriptions therefrom. Specifically, the deployment component 116 may access the repository 108, and search through the metadata in repository 108 to identify the standards that have metadata that meet at least one of the sets of conditions set forth in (1), (2), and (3) above. The deployment component 116 may then extract from each of these standards the associated description. On the other hand, if the metadata in repository 108 is stored in a database that is managed by a database manager, then the deployment component 116 may send one or more queries, specifying the conditions set forth in (1), (2), and (3) above, to the database manager to have the database manager search through the repository 108 to identify the applicable standards and to extract the associated descriptions therefrom. Either way, as a result of this process, the deployment component 116 will have all of the descriptions associated with all of the standards that apply to the course.

Using these standard descriptions, the deployment component 116 generates a syllabus for the course. To do so, the deployment component 116 processes each standard description in turn. If a standard description includes just text, the deployment component 116 inserts the text of the description into the syllabus. If the standard description includes text and formatting information, the deployment component 116 renders the text in accordance with the formatting information, and inserts the formatted text into the syllabus. If the standard description includes a reference to an object, the deployment component 116 accesses the object, renders it (if necessary), and then inserts the object (or the rendered version of the object or just the reference to the object) into the syllabus. The deployment component 116 does this for each of the standard descriptions extracted from the set of applicable standards. Thus, when complete, the syllabus will include descriptions for all of the standards that apply to the course.

After the syllabus is generated, the deployment component 116 may render the syllabus to the invoking user for review. In the present use case, the syllabus may include elements in addition to the descriptions for the standards. Upon reviewing the syllabus, the user may provide input indicating one or more changes to be made to the syllabus. In response, the deployment component 116 updates the syllabus in accordance with the user input (note: in the current use case, the deployment component 116 does not allow the user to add, delete, or change the descriptions for the standards). Thereafter, the deployment component 116 may render the updated syllabus to the user. The syllabus may also be printed.

In addition to automatically generating a syllabus for the course, the deployment component 116 may also perform other functions to enable and facilitate deployment of the course. This may include, for example, instantiating objects, exposing the course to students, activating links to objects, etc. Overall, the deployment component 116 may perform any functions and operations that are needed to make the course go “live”.

Thus far, the automatic syllabus generation capability (referred to hereinafter as the “syllabus service”) of the deployment component 116 has been described as being invoked during the course deployment process. While this service is invoked as part of the course deployment process, it should be noted that the syllabus service may also be invoked at other times. In one embodiment, the syllabus service of the deployment component 116 may be invoked at any time by any user or component (e.g. application, etc.) to automatically generate a syllabus for a course. In fact, the syllabus service need not be part of the deployment component 116 at all but rather may be a separate component that is invoked by the deployment component 116 during course deployment. This and other alternative implementations are within the scope of the present invention.

In the academic realm, it is sometimes necessary to generate a syllabus for a course that was available several months or even several years ago. When such a syllabus is generated, it should have the same content as the syllabus that was generated when the course was originally deployed. Since standards change over time, the standards that apply to a course now may not be the same standards that applied to the course when it was first deployed. Thus, a presently generated syllabus may contain different standards than the syllabus that was generated when the course was first deployed. To ensure that the same syllabus is generated for a course regardless of when the syllabus is generated, the syllabus service, in one embodiment, stores information that indicates which standards were applicable at the time the course was originally deployed. For example, when the syllabus service first generates a syllabus for a course, it may store the unique identifiers for all of the standards that apply to the course. If and when the syllabus is generated again, this stored information can be used to identify the standards that applied to the course at the time the course was first deployed. Doing so ensures that the same syllabus will be generated for the course regardless of when the syllabus is generated.

### Other Use Cases

In addition to the use case described above, embodiments of the present invention may be used in many other use cases. For example, rather than being an educational program, a project may be a construction project. In such a use case, the standards applicable to the project may be building codes (e.g. construction codes, plumbing codes, electrical codes, etc.), and the project description may be a construction plan that sets forth descriptions for all of the building codes that apply to the construction project. Which building codes apply may depend, for example, upon the structures being built and the tasks being performed in the construction project. For example, each structure or task may have one or more standards selection parameters associated therewith. These standards selection parameters may be checked against one or more applicability parameters in the metadata of the building codes to determine which building code or codes apply to the structure or task. By doing this for each structure or task in the construction project, all of the building codes that apply to the construction project can be identified. The descriptions associated with the applicable building codes may be extracted from the metadata and included in the construction plan.

Alternatively, a project may be a product design for a particular product (e.g. a semiconductor device, an engine, etc.). In such a case, the standards applicable to the project may be specifications and design standards, and the project description may be a design plan that sets forth descriptions of all of the specifications and design standards that apply to the product design. Which specifications and design standards apply may depend, for example, on the components included in the design. For example, each component may have one or more standards selection parameters associated therewith. These standards selection parameters may be checked against one or more applicability parameters in the metadata of the specifications and design standards to determine which specifications and design standards apply to the component. By doing this for each component in the product design, all of the specifications and design standards that apply to the product design can be identified. The descriptions associated with the applicable specifications and design standards may be extracted from the metadata and included in the design plan.

Alternatively, a project may be a product build for a particular product (e.g. a semiconductor device, an automobile, etc.). In such a case, the standards applicable to the project may be manufacturing process standards and best practices, and the project description may be a build plan that sets forth descriptions for all of the manufacturing process standards and best practices that apply to the product build. Which manufacturing process standards and best practices apply may depend, for example, upon the components or structures that are included in the product build. For example, each component or structure may have one or more standards selection parameters associated therewith. These standards selection parameters may be checked against one or more applicability parameters in the metadata of the manufacturing process standards and best practices to determine which manufacturing process standards and best practices apply to the component or structure. By doing this for each component or structure in the product build, all of the manufacturing process standards and best practices that apply to the product build can be identified. The descriptions associated with the applicable manufacturing process standards and best practices may be extracted from the metadata and included in the build plan.

Further alternatively, a project may be a software product design. In such a case, the standards applicable to the project may be design specifications, and the project description may be a design plan for the software that sets forth descriptions for all of the design specifications that apply to the software product design. Which design specifications apply may depend, for example, upon the functionalities and components included in the software product design. For example, each functionality or component may have one or more standards selection parameters associated therewith. These standards selection parameters may be checked against one or more applicability parameters in the metadata of the design specifications to determine which design specifications apply to the functionality or component. By doing this for each functionality or component in the software product design, all of the design specifications that apply to the software product design can be identified. The descriptions associated with the applicable design specifications may be extracted from the metadata and included in the design plan.

The above use cases are examples of just some of the use cases to which embodiments of the present invention may be applied. Many other use cases are possible, which may include but are not limited to use cases in the following areas: learning objectives; learning outcomes; course outcomes; programmatic outcomes; FCC Part 15 Certification; UL and CE Attestation; and test method Standards.

For the different uses cases, different standards will be used; hence, the metadata schemas will most likely differ from that shown in FIG. 3. Also, different standards selection parameters and different queries may be used to determine which standards apply to a project. Despite these differences that may exist between different use cases, the concepts taught herein may be applied to all of the use cases. The data model and application logic described herein are intended to be extensible and adaptable so that they can be adapted for use with a variety of intellectual and industrial standards, and a variety of project description types. Thus, these and other use cases are within the scope of the present invention.

### Hardware Overview

With reference to FIG. 4, there is shown a block diagram of a computer system that may be used to implement at least a portion of the present invention. Computer system 400 includes a bus 402 or other communication mechanism for communicating information, and one or more hardware processors 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques and components (e.g. repository 108, repository manager 110, project manager 112, build component 114, deployment component 116, etc.) described herein using customized hard-wired logic, one or more ASICs or FPGAs, firmware and/or program logic which in combination with the computer system causes or programs computer system 400 to be a special-purpose machine. According to one embodiment, the techniques disclosed herein for repository 108, repository manager 110, project manager 112, build component 114, and deployment component 116 are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage device 410, or other non-volatile storage for later execution.

At this point, it should be noted that although the invention has been described with reference to specific embodiments, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims.

What is claimed is:

1. A method, comprising:
obtaining information pertaining to a particular project, wherein the information comprises a set of one or more standards selection parameters that are usable to determine which one or more standards are applicable to the particular project;
accessing a repository, wherein the repository comprises metadata for a plurality of standards, and wherein the metadata for each standard comprises a description associated with the standard and one or more applicability parameters that are usable to determine whether the standard is applicable to one or more projects;
based at least in part upon the one or more standards selection parameters and the metadata in the repository, determining a set of one or more standards that are applicable to the particular project;
for each standard in the set of one or more standards, extracting the description associated with that standard from the repository; and
generating a project description for the particular project that includes the description associated with each of the standards in the set of one or more standards;
wherein the method is performed by one or more computer systems.

2. The method of claim 1, wherein the particular project is an educational course, wherein the plurality of standards comprises a plurality of educational standards, and wherein the project description comprises a syllabus for the educational course that includes descriptions associated with the educational standards that apply to the educational course.

3. The method of claim 2, wherein the standards selection parameters include a course code for the educational course, and wherein determining a set of one or more standards that are applicable to the particular project comprises:
determining which of the plurality of educational standards has an applicability parameter that indicates that the educational standard is associated with the course code.

4. The method of claim 2, wherein the standards selection parameters include a location parameter that indicates a particular location where the educational course is available, and wherein determining a set of one or more standards that are applicable to the particular project comprises:
determining which of the plurality of educational standards has an applicability parameter that indicates that the educational standard is applicable to courses in the particular location.

5. The method of claim 2, wherein the standard selection parameters include a date parameter that indicates a date on which the educational course is made available, and wherein determining a set of one or more standards that are applicable to the particular project comprises:
determining which of the plurality of educational standards has a creation date that is less than or equal to the date on which the education course is made available and a modified date that is either null or is greater than the date on which the education course is made available.

6. The method of claim 1, wherein the particular project is a construction project, wherein the plurality of standards comprises a plurality of building codes, and wherein the project description comprises a construction plan for the construction project that includes descriptions associated with the building codes that apply to the construction project.

7. The method of claim 1, wherein the particular project is a product design for a particular product, wherein the plurality of standards comprises a plurality of specifications, and wherein the project description comprises a design plan for the product design that includes descriptions associated with the specifications that apply to the construction project.

8. The method of claim 1, wherein the particular project is a product build for a particular product, wherein the plurality of standards comprises a plurality of manufacturing process standards, and wherein the project description comprises a build plan for the product build that includes descriptions associated with the manufacturing process standards that apply to the product build.

9. The method of claim 1, wherein the particular project is a software product design for a particular software product, wherein the plurality of standards comprises a plurality of design specifications, and wherein the project description comprises a design plan for the software product design that includes descriptions associated with the design specifications that apply to the software product design.

10. The method of claim 1, further comprising:
maintaining the metadata in the repository, wherein maintaining comprises allowing a user to add metadata to, remove metadata from, and update metadata in the repository.

11. The method of claim 1, wherein the set of one or more standards comprises a particular standard that has a particular description associated therewith, wherein the particular description comprises text and formatting information, and wherein generating the project description comprises:
formatting the text in accordance with the formatting information to derive a set of formatted text; and
including the formatted text in the project description.

12. The method of claim 1, wherein the set of one or more standards comprises a particular standard that has a particular description associated therewith, wherein the particular description comprises a reference to an object, and wherein generating the project description comprises:
accessing the object referenced in the particular description; and
including the object in the project description.

13. A system comprising one or more computer systems, wherein the one or more computer systems are configured to perform the operations of:
obtaining information pertaining to a particular project, wherein the information comprises a set of one or more standards selection parameters that are usable to determine which one or more standards are applicable to the particular project;
accessing a repository, wherein the repository comprises metadata for a plurality of standards, and wherein the metadata for each standard comprises a description associated with the standard and one or more applicability parameters that are usable to determine whether the standard is applicable to one or more projects;
based at least in part upon the one or more standards selection parameters and the metadata in the repository, determining a set of one or more standards that are applicable to the particular project;
for each standard in the set of one or more standards, extracting the description associated with that standard from the repository; and
generating a project description for the particular project that includes the description associated with each of the standards in the set of one or more standards;
wherein the method is performed by one or more computer systems.

14. The system of claim 13, wherein the particular project is an educational course, wherein the plurality of standards comprises a plurality of educational standards, and wherein the project description comprises a syllabus for the educational course that includes descriptions associated with the educational standards that apply to the educational course.

15. The system of claim 14, wherein the standards selection parameters include a course code for the educational course, and wherein determining a set of one or more standards that are applicable to the particular project comprises:
determining which of the plurality of educational standards has an applicability parameter that indicates that the educational standard is associated with the course code.

16. The system of claim 14, wherein the standards selection parameters include a location parameter that indicates a particular location where the educational course is available, and wherein determining a set of one or more standards that are applicable to the particular project comprises:
determining which of the plurality of educational standards has an applicability parameter that indicates that the educational standard is applicable to courses in the particular location.

17. The system of claim 14, wherein the standard selection parameters include a date parameter that indicates a date on which the educational course is made available, and wherein determining a set of one or more standards that are applicable to the particular project comprises:
determining which of the plurality of educational standards has a creation date that is less than or equal to the date on which the education course is made available and a modified date that is either null or is greater than the date on which the education course is made available.

18. The system of claim 13, wherein the particular project is a construction project, wherein the plurality of standards comprises a plurality of building codes, and wherein the project description comprises a construction plan for the construction project that includes descriptions associated with the building codes that apply to the construction project.

19. The system of claim 13, wherein the particular project is a product design for a particular product, wherein the plurality of standards comprises a plurality of specifications, and wherein the project description comprises a design plan for the product design that includes descriptions associated with the specifications that apply to the construction project.

20. The system of claim 13, wherein the particular project is a product build for a particular product, wherein the plurality of standards comprises a plurality of manufacturing process standards, and wherein the project description comprises a build plan for the product build that includes descriptions associated with the manufacturing process standards that apply to the product build.

21. The system of claim 13, wherein the particular project is a software product design for a particular software product, wherein the plurality of standards comprises a plurality of design specifications, and wherein the project description comprises a design plan for the software product design that includes descriptions associated with the design specifications that apply to the software product design.

22. The system of claim 13, wherein the one or more computer systems are configured to further perform the operation of:
maintaining the metadata in the repository, wherein maintaining comprises allowing a user to add metadata to, remove metadata from, and update metadata in the repository.

23. The system of claim 13, wherein the set of one or more standards comprises a particular standard that has a particular description associated therewith, wherein the particular description comprises text and formatting information, and wherein generating the project description comprises:
formatting the text in accordance with the formatting information to derive a set of formatted text; and
including the formatted text in the project description.

24. The system of claim 13, wherein the set of one or more standards comprises a particular standard that has a particular description associated therewith, wherein the particular description comprises a reference to an object, and wherein generating the project description comprises:
accessing the object referenced in the particular description; and
including the object in the project description.

25. A computer readable storage medium storing instructions which, when executed by one or more processors, cause the one or more processors to perform the operations of:
obtaining information pertaining to a particular project, wherein the information comprises a set of one or more standards selection parameters that are usable to determine which one or more standards are applicable to the particular project;
accessing a repository, wherein the repository comprises metadata for a plurality of standards, and wherein the metadata for each standard comprises a description associated with the standard and one or more applicability parameters that are usable to determine whether the standard is applicable to one or more projects;
based at least in part upon the one or more standards selection parameters and the metadata in the repository, determining a set of one or more standards that are applicable to the particular project;
for each standard in the set of one or more standards, extracting the description associated with that standard from the repository; and
generating a project description for the particular project that includes the description associated with each of the standards in the set of one or more standards.
